(19) United States
(12) Patent Application Publication
(10) Pub. No.: US 2010/0015442 A1
(43) Pub. Date: Jan. 21, 2010

(54) ADHESIVE COMPOSITION, METHOD FOR PRODUCING THE SAME AND ADHESIVE BODY

(75) Inventors: Yoshio Shimoura, Osaka (JP); Katsunori Toyoshima, Osaka (JP); Atsuhiro Nagao, Saitama (JP); Takashi Toyoizumi, Tokyo (JP); Masashi Shimakage, Tokyo (JP); Iwakazu Hattori, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: JSR CORPORATION, Chuo-ku (JP)

(21) Appl. No.: 12/298,815

(22) PCT Filed: Apr. 27, 2007
(86) PCT No.: PCT/JP07/59247

§ 371 Date: May 18, 2009

(30) Foreign Application Priority Data
Apr. 28, 2006 (JP) 2006-124646

(51) Int. Cl. C08L 53/02; B32B 25/00

(52) U.S. Cl. 428/355 BL; 524/505

(57) ABSTRACT

A pressure-sensitive adhesive composition includes a component (i) and a component (ii) and a component (i), the component (i) being a copolymer (I) obtained by hydrogenating a copolymer (I′) having a structure shown by [A-B]ₙ, the component (ii) being a copolymer (II) obtained by hydrogenating a copolymer (II′) including the polymer block A having at least 80% of an aromatic alkenyl compound unit content at a terminal and at least one block B having a specified conjugated diene compound unit content and a specified conjugated diene compound-derived vinyl bond content in the intermediate portion, the mass ratio of component (i) to the component (ii), and that in terms of the total amount of A to B included in the copolymer (I′) and the copolymer (II′) being within given ranges, respectively, 80% or more of conjugated diene compound-derived double bonds included in the copolymers (I′) and (II′) being hydrogenated.

### TECHNICAL FIELD

The present invention relates to a pressure-sensitive adhesive composition including a hydrogenated block copolymer obtained by hydrogenating a block copolymer that includes a polymer block having an aromatic alkenyl compound unit as the main repeating unit and a polymer block having a conjugated diene compound unit as the main repeating unit, a method of producing the same, and a pressure-sensitive adhesive body.

### BACKGROUND ART

The surface of a material (e.g., metal sheet, coated steel sheet, synthetic resin sheet, coated plywood board, name plate, or glass sheet) has been protected from contamination and damage by covering the surface of the material with a surface protective film.

A surface protective film normally has a film-shaped substrate and a pressure-sensitive adhesive layer formed on the surface of the substrate. The film-shaped substrate of the surface protective film is bonded to the surface of a protection target material utilizing the pressure-sensitive adhesive layer so that the surface protective film protects the surface of the protection target material from contamination and damage.

As a pressure-sensitive adhesive composition for forming the pressure-sensitive adhesive layer of the surface protective film, a pressure-sensitive adhesive composition including a hydrogenated block copolymer obtained by hydrogenating a block copolymer that contains a polymer block having, for example, an aromatic alkenyl compound unit as the main repeating unit and a polymer block having a conjugated diene compound unit as the main repeating unit has been proposed. Specifically, a pressure-sensitive adhesive composition for a surface protective film that contains a hydrogenated block copolymer obtained by hydrogenating a block copolymer having a structure shown by [A-B] (wherein A represents a polymer block A, and B represents a polymer block B) or a block copolymer having a structure shown by [A-B-A] has been disclosed (see Patent Documents 1 and 2, for example).
Patent Document 1: JP-B-6-23365
Patent Document 2: Japanese Patent No. 2713519

### DISCLOSURE OF THE INVENTION

However, the pressure-sensitive adhesive compositions disclosed in Patent Documents 1 and 2 may give rise to a problem in which a pressure-sensitive adhesive layer is lifted up from the surface of an adherend when a certain period has elapsed after bonding a film to the surface of the adherend so that the film peels off (this problem is hereinafter referred to as “lifting”), or a problem in which a pressure-sensitive adhesive remains on the surface of an adherend after peeling off a film from the surface of the adherend so that the surface of the adherend is contaminated (this problem is hereinafter referred to as “adhesive residue”). Therefore, the pressure-sensitive adhesive compositions disclosed in Patent Documents 1 or 2 are not necessarily satisfactory. Specifically, the pressure-sensitive adhesive compositions disclosed in Patent Documents 1 and 2 requires a further improvement in order to prevent lifting or an adhesive residue.

The present invention was conceived in order to solve the above-mentioned problems. An object of the present invention is to provide a pressure-sensitive adhesive composition and a pressure-sensitive adhesive body that can effectively prevent the problems such as lifting and an adhesive residue.

The inventors of the present invention conducted extensive studies in order to solve the above-mentioned problems. As a result, the inventors found that the above-mentioned problems can be solved by precisely controlling the structure, composition, and properties of a block copolymer included in a pressure-sensitive adhesive composition. This finding has lead to the completion of the present invention. Specifically, the present invention provides a pressure-sensitive adhesive composition, a method of producing the same, and a pressure-sensitive adhesive body given below.

[1] A pressure-sensitive adhesive composition comprising a copolymer composition that includes a component (i) and a component (ii), the component (i) being a copolymer (I) obtained by hydrogenating a conjugated diene compound-derived double bond of a copolymer (I′) that includes a polymer block A and a polymer block B, the copolymer (I′) having a structure shown by [A-B]ₙ (wherein “A” represents the polymer block A, “B” represents the polymer block B, and “n” represents an integer from 1 to 3) and having an aromatic alkenyl compound unit content of 5 mass % or more and less than 30 mass %, the component (ii) being a copolymer (II) obtained by hydrogenating a conjugated diene compound-derived double bond of a copolymer (II′) that includes the polymer block A and the polymer block B, the copolymer (II′) including the polymer blocks A at two terminals and at least one polymer block B in the intermediate portion, and having an aromatic alkenyl compound unit content of 5 mass % or more and less than 30 mass %, the mass ratio of the component (i) and the component (ii) being 90:10 to 10:90, the mass ratio of the total amount of the polymer block A and the total amount of the polymer block B included in the copolymer (I′) and the copolymer (II′) being 5:95 to 29:71, 80% or more of conjugated diene compound-derived double bonds included in the copolymer (I′) and the copolymer (II′) being hydrogenated, the polymer block A being a polymer block having an aromatic alkenyl compound unit content of 80 mass % or more, and the polymer block B being a polymer block having a conjugated diene compound unit content of 50 mass % or more and a conjugated diene compound-derived vinyl bond content of 50% or more.

[2] The pressure-sensitive adhesive composition according to [1], wherein the copolymer (I′) and the copolymer (II′) have an aromatic alkenyl compound unit content of 5 mass % or more and less than 25 mass %.

[3] The pressure-sensitive adhesive composition according to [1] or [2], wherein the copolymer (I′) is a copolymer having a structure shown by [A-B], the copolymer (II′) is a copolymer having a structure shown by [A-B-A], and the mass ratio of the component (i) and the component (ii) is 80:20 to 20:80, provided that the polymer blocks “A” or the polymer blocks “B” may be the same or different polymer blocks.

[4] The pressure-sensitive adhesive composition according to any one of [1] to [3], wherein the copolymer (I′) is a copolymer having a structure shown by [A-B], the copolymer (II′) is a copolymer having a structure shown by {[A-B]ₓ-Y} (wherein “x” represents an integer equal to or larger than 2, and “Y” represents a coupling agent residue), and the mass ratio of the component (i) and the component (ii) is 50:50 to 20:80, provided that the polymer blocks “A” or the polymer blocks “B” may be the same or different polymer blocks.

[5] The pressure-sensitive adhesive composition according to any one of [1] to [4], wherein the polymer block A includes a styrene unit as the aromatic alkenyl compound unit, and the polymer block B includes at least one repeating unit selected from the group consisting of a 1,3-butadiene unit and an isoprene unit as the conjugated diene compound unit.

[6] The pressure-sensitive adhesive composition according to any one of [1] to [4], wherein the copolymer composition further includes a tackifier as a component (iii) in addition to the component (i) and the component (ii), the content of the component (iii) being 2 to 50 parts by mass with respect to the total amount of 100 parts by mass of the component (i) and the component (ii).

[7] The pressure-sensitive adhesive composition according to any one of [1] to [6], wherein the copolymer composition has an MFR measured at a temperature of 230° C. and a load of 21.2 N of 1 to 100 g/10 min, a loss tangent tan δ (20° C.) in a viscoelastic spectrum of 0.15 or less, a loss tangent tan δ (80° C.) of 0.10 or more, and a storage modulus G′ (20° C.) of 1.8×10⁶ Pa or less.

[8] A method of producing the pressure-sensitive adhesive composition according to any one of [1] to [7], the method comprising a first step of synthesizing a copolymer (I′-1) having a structure shown by [A-B] by block polymerization, a second step of coupling part of the copolymer (I′-1) having a structure shown by [A-B] using a coupling agent Y-Zₓ (wherein “Y” represents a coupling agent residue, “Z” represents an elimination group, and “X” represents an integer equal to or larger than 2) to synthesize a copolymer (II′-1) having a structure shown by {[A-B]ₓ-Y}, and a third step of hydrogenating the copolymer (I′-1) having a structure shown by [A-B] and the copolymer (II′-1) having a structure shown by {[A-B]ₓ-Y} to obtain a copolymer composition in which 80% or more of conjugated diene compound-derived double bonds included in the copolymer (I′-1) and the copolymer (II′-1) are hydrogenated, the polymer block A being a polymer block having an aromatic alkenyl compound unit content of 80 mass % or more, and the polymer block B being a polymer block having a conjugated diene compound unit content of 50 mass % or more and a conjugated diene compound-derived vinyl bond content of 50% or more.

[9] A pressure-sensitive adhesive body comprising a substrate and a pressure-sensitive adhesive layer formed on the surface of the substrate, the pressure-sensitive adhesive layer including the pressure-sensitive adhesive composition according to any one of [1] to [7].

The pressure-sensitive adhesive composition and the pressure-sensitive adhesive body according to the present invention can effectively prevent a problem in which a pressure-sensitive adhesive layer is lifted up from the surface of an adherend when a certain period has elapsed after bonding a film to the surface of the adherend so that the film peels off (“lifting”), or a problem in which a pressure-sensitive adhesive remains on the surface of an adherend after peeling off a film from the surface of the adherend so that the surface of the adherend is contaminated (“adhesive residue”).

### BEST MODE FOR CARRYING OUT THE INVENTION

Preferred embodiments of the present invention are described in detail below. Note that the present invention is not limited to the following embodiments, but includes all other embodiments within the scope of the invention. Note that the term “repeating unit derived from a monomer X” may be referred to as “unit X”.

### [1] Pressure-Sensitive Adhesive Composition

A pressure-sensitive adhesive composition according to the present invention includes a copolymer composition that includes a component (i) and a component (ii) as essential components. Each of the component (i) and the component (ii) is a copolymer obtained by hydrogenating a conjugated diene compound-derived double bond of a block polymer that includes a polymer block A and a polymer block B given below. First, the polymer block A and the polymer block B are described below.
Polymer block A: polymer block having an aromatic alkenyl compound unit content of 80 mass % or more
Polymer block B: polymer block having a conjugated diene compound unit content of 50 mass % or more and a conjugated diene compound-derived vinyl bond content of 50% or more

### [1-1] Polymer Block A

The “polymer block A” is a polymer block having an aromatic alkenyl compound unit content of 80 mass % or more.

The term “aromatic alkenyl compound unit” used herein refers to a repeating unit derived from an aromatic alkenyl compound. Examples of the “aromatic alkenyl compound” include styrene, t-butylstyrene, α-methylstyrene, p-methylstyrene, p-ethylstyrene, divinylbenzene, 1,1-diphenylstyrene, vinylnaphthalene, vinylanthracene, N,N-diethyl-p-aminoethylstyrene, vinylpyridine, and the like. It is preferable that the “aromatic alkenyl compound unit” be a styrene unit from the viewpoint of industrial availability of the raw material.

It is necessary that the “polymer block A” include the aromatic alkenyl compound unit as the main repeating unit. Specifically, the polymer block A must have an aromatic alkenyl compound unit content of 80 mass % or more, and this provides advantage that the thermoplasticity of the pressure-sensitive adhesive composition can be improved by setting the aromatic alkenyl compound unit content at 80 mass % or more so that the pressure-sensitive adhesive composition can be easily recycled. Examples of a repeating unit other than the aromatic alkenyl compound unit that may be included in the polymer block A in the range of less than 20 mass % include a repeating unit derived from a compound copolymerizable with the aromatic alkenyl compound, such as repeating units derived from a conjugated diene compound and a (meth)acrylate compound. In particular, 1,3-butadiene and isoprene are preferable from the viewpoint of high copolymerizability with the aromatic alkenyl compound.

### [1-2] Polymer Block B

The “polymer block B” is a polymer block having a conjugated diene compound unit content of 50 mass % or more and a conjugated diene compound-derived vinyl bond content of 50% or more.

The term “conjugated diene compound unit” included in the “polymer block B” refers to a repeating unit derived from a conjugated diene compound. Examples of the “conjugated diene compound” include 1,3-butadiene, isoprene, 2,3-dimethyl-1,3-butadiene, 1,3-pentadiene, 2-methyl-1,3-octadiene, 1,3-hexadiene, 1,3-cyclohexadiene, 4,5-diethyl-1,3-octadiene, 3-butyl-1,3-octadiene, myrcene, chloroprene, and the like. It is preferable that the “conjugated diene compound unit” be at least one repeating unit selected from the group consisting of a 1,3-butadiene unit and an isoprene unit from the viewpoint of industrial availability of the raw material.

It is necessary that the “polymer block B” include the conjugated diene compound unit as the main repeating unit. Specifically, the polymer block B must have a conjugated diene compound unit content of 50 mass % or more (50 to 100 mass %). It is preferable that the polymer block B have a conjugated diene compound unit content of 70 to 100 mass %, and more preferably 90 to 100 mass %. The flexibility of the pressure-sensitive adhesive composition can be improved by setting the conjugated diene compound unit content at 50 mass % or more. Examples of a repeating unit other than the conjugated diene compound unit that may be included in the polymer block B in the range of less than 50 mass % include a repeating unit derived from a compound copolymerizable with the conjugated diene compound, such as a repeating unit derived from an aromatic alkenyl compound. In particular, styrene is preferable from the viewpoint of high copolymerizability with the conjugated diene compound.

The “polymer block B” must have a vinyl bond content (i.e., the total content of a 1,2-vinyl bond and a 3,4-vinyl bond. This total content is hereinafter referred to as “vinyl content”) of 50% or more. It is preferable that the polymer block B have a vinyl content of 50 to 90%, and more preferably 60 to 80%. There is an advantage that a pressure-sensitive adhesive composition that exhibits tack and adhesion in a well-balanced manner can be obtained by setting the vinyl bond content at 50% or more.

Next, the component (i) and the component (ii) that are copolymers obtained by hydrogenating a conjugated diene compound-derived double bond of a polymer that includes the polymer block A and the polymer block B are described below.

### [1-3] Component (i)

The “component (i)” is a copolymer (I) obtained by hydrogenating a conjugated diene compound-derived double bond of a copolymer (I′) that includes the polymer block A and the polymer block B, the copolymer (I′) having a structure shown by [A-B]ₙ (wherein “A” represents the polymer block A, “B” represents the polymer block B, and “n” represents an integer from 1 to 3) and having an aromatic alkenyl compound unit content of 5 mass % or more and less than 30 mass %.

Examples of the polymer having a structure shown by [A-B]ₙ, in which “n” represents an integer from 1 to 3, include a block copolymer having a structure shown by [A-B], a block copolymer having a structure shown by [A-B-A-B], and a block copolymer having a structure shown by [A-B-A-B-A-B]. In these block copolymers, each polymer block may be the same or different (e.g., [A₁-B₁-A₂-B₂]). These block copolymers may be a tapered block copolymer in which the aromatic alkenyl compound unit content or the conjugated diene compound unit content varies continuously in the block, or may be a random block copolymer.

In the structure shown by [A-B]ₙ, it is preferable that the content of the terminal polymer block B account for 2 mass % or more of the entire copolymer. This ensures that the effect of the polymer block B is reliably achieved. On the other hand, when the content of the terminal polymer block A of a structure shown by [-B-A] accounts for less than 2 mass % of the entire copolymer, the same effect as that achieved when the terminal is the polymer block B can be achieved. Specifically, the polymer block B substantially forms the terminal of the above-mentioned structure.

“n” must be an integer from 1 to 3. The industrial productivity can be increased by setting n within this range. It is not preferable that “n” be 4 or more because this leads to a decrease in the industrial productivity. Meanwhile, it is preferable that n be 1 to 2, and more preferably 1, from the viewpoint of improving adhesion and material strength. Specifically, a “block copolymer having a structure shown by [A-B]” is particularly preferable as the polymer having a structure shown by [A-B]ₙ.

The copolymer (I′) must have an aromatic alkenyl compound unit content of 5 mass % or more and less than 30 mass %. Apressure-sensitive adhesive composition that exhibits an appropriate holding power and a capability of following elevations or depressions on the surface of an adherend can be obtained by setting the aromatic alkenyl compound unit content at 5 mass % or more and less than 30 mass %. It is preferable that the aromatic alkenyl compound unit content be 5 mass % or more and less than 25 mass %, more preferably 5 to 20 mass %, and particularly preferably 7 to 20 mass %, taking into account the capability of following elevations or depressions on the surface of an adherend.

The molecular weight of the component (i) is not particularly limited. The weight average molecular weight of the component (i) is preferably 30,000 to 500,000, more preferably 80,000 to 300,000, and particularly preferably 100,000 to 200,000. If the weight average molecular weight of the component (i) is 30,000 to 500,000, a copolymer composition that includes the component (i) (resultantly, the component (i) and the component (ii)) can be easily produced industrially. If the weight average molecular weight of the component (i) is less than 30,000, the polymer may adhere to production facilities and the like in the steps of removing a solvent from the polymer and drying the polymer. This may make it difficult to industrially produce the component (i) and the like. If the weight average molecular weight of the component (i) is more than 500,000, the solubility in a solvent and meltability may deteriorate so that it may be difficult to form a pressure-sensitive adhesive body. The term “weight average molecular weight” used herein refers to a polystyrene-reduced weight average molecular weight determined by gel permeation chromatography (GPC).

### [1-4] Component (ii)

The “component (ii)” is a copolymer (II) obtained by hydrogenating a conjugated diene compound-derived double bond of a copolymer (II′) that includes the polymer block A and the polymer block B, the copolymer (II′) including the polymer blocks A at at least two terminals and at least one polymer block B in the intermediate portion, and having an aromatic alkenyl compound unit content of 5 mass % or more and less than 30 mass %.

Examples of the “polymer including the polymer blocks A at at least two terminals and at least one polymer block B in the intermediate portion” include a block copolymer having a structure shown by [A₁-B-A₂], [A₁-B₁-B₂-A₂], [A₁-B-A₂-A₃], [A₁-B₁-B₂-B₁-A₂], or the like (wherein A₁, A₂, and A₃ represent polymer blocks that satisfy the condition for the polymer block A, and B₁ and B₂ represent polymer blocks that satisfy the condition for the polymer block B). In these block copolymers, the polymer blocks, for example, A₁, A₂, and A₃ or B₁ and B₂ may be the same or different. These block copolymers may be a tapered block copolymer in which the aromatic alkenyl compound unit content or the conjugated diene compound unit content varies continuously in the block, or may be a random block copolymer.

It is preferable that the content of the terminal polymer blocks A account for 2 mass % or more of the entire copolymer. This ensures that the effect of the polymer block A is reliably achieved. On the other hand, when the content of the terminal polymer block B of a structure shown by [-A-B] accounts for less than 2 mass % of the entire copolymer, the same effect as that achieved when the terminal is the polymer block A can be achieved. Specifically, the polymer block A substantially forms the terminal of the above-mentioned structure.

As the “polymer including the polymer blocks A at at least two terminals and at least one polymer block B in the intermediate portion”, it is also preferable to use a polymer having a structure shown by {[A-B]ₓ-Y} (wherein A represents the polymer block A, B represents the polymer block B, x represents an integer equal to or larger than 2, and Y represents a coupling agent residue. A or B may respectively be the same or different polymer blocks).

A polymer having the above-mentioned structure may be obtained by coupling polymers having a configuration in which the portion B of a structure shown by [A-B-A] has a structure shown by [B-Y-B] and having a structure shown by [A-B], for example. Therefore, the component (i) and the component (ii) can be synthesized by a one-pot process. The details of the coupling method and the like are described at the section relating to a production method.

“x” must be an integer equal to or larger than 2. Therefore, the coupling product includes a coupling product (i.e., star polymer) of three or more molecules in addition to a coupling product of two molecules depending on the type of coupling agent. However, a side reaction may occur when producing the component (ii) by coupling a large number of polymers so that it may be difficult to control the properties of the polymer. Therefore, it is preferable that “x” be 2 to 4.

The copolymer (II′) must have an aromatic alkenyl compound unit content of 5 mass % or more and less than 30 mass % for the same reason as that for the copolymer (I′). It is more preferable that the copolymer (II′) have an aromatic alkenyl compound unit content of 5 mass % or more and less than 25 mass %, and particularly preferably 5 to 20 mass %.

The molecular weight of the component (ii) is not particularly limited. The weight average molecular weight of the component (ii) is preferably 50,000 to 500,000, and more preferably 50,000 to 300,000. If the weight average molecular weight of the component (ii) is 50,000 to 500,000, a copolymer composition that includes the component (ii) (resultantly, the component (i) and the component (ii)) can be easily produced industrially. If the weight average molecular weight of the component (ii) is less than 30,000, the polymer may adhere to production facilities and the like in the steps of removing a solvent from the polymer and drying the polymer. This may make it difficult to industrially produce the component (ii) and the like. If the weight average molecular weight of the component (ii) is more than 500,000, the solubility in a solvent and meltability may deteriorate so that it may be difficult to form a pressure-sensitive adhesive body.

### [1-5] Copolymer Composition

The pressure-sensitive adhesive composition according to the present invention includes the copolymer composition that includes the component (i) and the component (ii). The mass ratio of the component (i) and the component (ii) in the copolymer composition must be 90:10 to 10:90. When the amount of the component (i) is 10 parts by mass or more with respect to the total amount of 100 parts by mass of the component (i) and the component (ii), a situation in which a pressure-sensitive adhesive layer is lifted up from the surface of an adherend so that a film peels off (lifting) can be effectively prevented. However, when the amount of the component (ii) is 10 parts by mass or more with respect to the total amount of 100 parts by mass of the component (i) and the component (ii), a situation in which a pressure-sensitive adhesive remains on the surface of an adherend to contaminate the surface of the adherend when peeling off a film from the surface of the adherend (adhesive residue) can be effectively prevented.

The mass ratio of the component (i) and the component (ii) is preferably 50:50 to 20:80 from the viewpoint of more reliably preventing lifting of a pressure-sensitive adhesive layer and an adhesive residue.

The copolymer composition must be prepared so that the mass ratio of the total amount of the polymer block A and the total amount of the polymer block B included in the copolymer (I′) and the copolymer (II′) is 5:95 to 29:71. When the amount of the polymer block A is 5 parts by mass or more with respect to the total amount of 100 parts by mass of the polymer block A and the polymer block B, the resulting pressure-sensitive adhesive layer can be provided with a moderate holding power. When the amount of the polymer block B is 71 parts by mass or more with respect to the total amount of 100 parts by mass of the polymer block A and the polymer block B, the resulting pressure-sensitive adhesive layer has an excellent capability of following elevations or depressions on the surface of an adherend so that the surface of the adherend can be reliably protected.

In order to further improve the capability of following elevations or depressions on the surface of an adherend, tackiness, and moldability, it is preferable that the mass ratio of the total amount of the polymer block A and the total amount of the polymer block B be 5:95 to 25:75, more preferably 5:95 to 20:80, and particularly preferably 5:95 to 15:85.

In the pressure-sensitive adhesive composition according to the present invention, 80% or more of conjugated diene compound-derived double bonds included in the copolymer (I′) and the copolymer (II′) have been hydrogenated. Specifically, the hydrogenation rate of the copolymer (I′) and the copolymer (II′) must be 80 to 100%. It is preferable that the hydrogenation rate of the copolymer (I′) and the copolymer (II′) be 90 to 100%, and more preferably 95 to 100%. A pressure-sensitive adhesive composition that exhibits excellent heat resistance can be obtained by setting the hydrogenation rate at 80% or more, and particularly at 95% or more. The term “hydrogenation rate” used herein refers to a hydrogenation rate calculated from a ¹H-NMR spectrum at 270 MHz using carbon tetrachloride as a solvent.

It is preferable that the copolymer composition have an aromatic alkenyl compound unit content of 5 mass % or more and less than 25 mass %, more preferably 5 to 20 mass %, and particularly preferably 7 to 20 mass %. A pressure-sensitive adhesive composition that exhibits an appropriate holding power and a capability of following elevations or depressions on the surface of an adherend can be obtained by setting the aromatic alkenyl compound unit content at 5 mass % or more and less than 25 mass %. Moreover, the capability of following elevations or depressions on the surface of an adherend can be improved.

The molecular weight of the copolymer composition is not particularly limited. The weight average molecular weight of the copolymer composition is preferably 30,000 to 500,000, more preferably 80,000 to 300,000, and particularly preferably 100,000 to 200,000. The copolymer composition can be easily produced industrially by setting the weight average molecular weight of the copolymer composition in the range from 30,000 to 500,000. If the weight average molecular weight of the copolymer composition is less than 30,000, the polymer may adhere to production facilities and the like when removing a solvent from the polymer and drying the polymer. This may make it difficult to industrially produce the copolymer composition. If the weight average molecular weight of the copolymer composition is more than 500,000, the solubility in a solvent and meltability may deteriorate so that it may be difficult to form a pressure-sensitive adhesive body.

It is preferable that the copolymer composition have an MFR measured at a temperature of 230° C. and a load of 21.2 N (hereinafter referred to as “MFR₂₃₀° _{C., 21.2 N}”) of 1 to 100 g/10 min. The extrudability and the productivity of the pressure-sensitive adhesive composition can be significantly improved by setting the MFR₂₃₀° _{C., 21.2 N} within the above range.

It is preferable that the MFR₂₃₀° _{C., 21.2 N} be 1 to 50 g/10 min in order to further improve the extrudability of the pressure-sensitive adhesive composition. In order to adjust the MFR₂₃₀° _{C., 21.2 N} to 1 to 100 g/10 min, it is necessary to appropriately control the conditions of the weight average molecular weight, the mass ratio of the component (i) and the component (ii), the aromatic alkenyl compound unit content, the vinyl content of the conjugated diene compound unit of the polymer block B included in the component (i) and the component (ii), the hydrogenation rate, and the like. The term “MFR₂₃₀° _{C., 21.2 N}” used herein refers to an MFR measured in accordance with the method described in JIS K7210.

The copolymer composition must have a loss tangent tan δ (80° C.) of 0.10 or more. Lifting of a pressure-sensitive adhesive layer can be prevented by setting the loss tangent tan δ (80° C.) at 0.10 or more. It is preferable that the copolymer composition have a loss tangent tan δ (80° C.) of 0.10 to 0.50, and more preferably 0.10 to 0.20, taking the balance with heat resistance into consideration. In order to adjust the loss tangent tan δ (80° C.) to 0.10 or more, it is necessary to appropriately control the conditions of the aromatic alkenyl compound unit content, the vinyl content of the conjugated diene compound unit of the polymer block B included in the component (i) and the component (ii), the hydrogenation rate, and the like.

It is preferable that the copolymer composition have a loss tangent tan δ (20° C.) of 0.15 or less. The high-speed peelability can be improved by setting the loss tangent tan δ (20° C.) at 0.15 or less. In order to adjust the loss tangent tan δ (20° C.) to 0.15 or less, it is necessary to appropriately control the conditions of the vinyl content of the conjugated diene compound unit of the polymer block B included in the component (i) and the component (ii), the hydrogenation rate, and the like.

It is preferable that the copolymer composition have a storage modulus G′ (20° C.) of 1.8×10⁶ Pa or less. An appropriate adhesion can be obtained by setting the storage modulus G′ (20° C.) at 1.8×10⁶ Pa or less. It is more preferable that the copolymer composition have a storage modulus G′ (20° C.) of 1.0×10⁵ to 1.5×10⁶ Pa, taking the productivity into consideration. In order to adjust the storage modulus G′ (20° C.) of 1.8×10⁶ Pa or less, it is necessary to appropriately control the conditions of the aromatic alkenyl compound unit content, the vinyl content of the conjugated diene compound unit of the polymer block B included in the component (i) and the component (ii), the hydrogenation rate, and the like.

The terms “tan δ (80° C.)”, “tan δ (20° C.)”, and “G′ (20° C.)” used herein refers to dynamic viscoelasticity values measured in a temperature variance range of −60 to 100° C. at a temperature increase rate of 5° C./min, a strain of 0.14%, and a frequency of 10 Hz using an ARES measuring instrument (manufactured by TA Instruments Japan).

[1-6] Component (iii)

It is preferable that the pressure-sensitive adhesive composition according to the present invention include a tackifier as a component (iii). The initial tackiness of the pressure-sensitive adhesive composition can be improved by incorporating the component (iii) in addition to the component (i) and the component (ii) as essential components.

As the tackifier, a material generally used for a tackifier, such as a petroleum resin (e.g., aliphatic copolymer, aromatic copolymer, aliphatic-aromatic copolymer, or alicyclic copolymer), a coumarone-indene resin, a terpene resin, a terpene-phenol resin, a rosin resin (e.g., rosin polymer), an (alkyl)phenol resin, a xylene resin, or a hydrogenated product thereof, may be used. These tackifiers may be used either individually or in combination.

In the pressure-sensitive adhesive composition, the component (iii) is preferably used in an amount of 2 to 50 parts by mass, more preferably 5 to 40 parts by mass, and particularly preferably 5 to 30 parts by mass, with respect to the total amount of 100 parts by mass of the of the component (i) and the component (ii). Lifting can be prevented by adjusting the content of the component (iii) to 2 parts by mass or more. An adhesive residue can be preferably prevented by adjusting the content of the component (iii) to 50 parts by mass or less.

### [1-7] Other Additives

The pressure-sensitive adhesive composition according to the present invention may include additives which may be added to a pressure-sensitive adhesive composition, such as an antioxidant, a UV absorber, a coloring agent, a light stabilizer, a heat polymerization inhibitor, an anti-foaming agent, a leveling agent, an antistatic agent, a surfactant, a preservative, a filler and the like other than the component (i), the component (ii) and the component (iii).

### [2] Production Method

The pressure-sensitive adhesive composition according to the present invention may be produced by the following method (blending method), for example. In the following description, “A” and “B” indicate the polymer block A and the polymer block B, respectively. It is preferable to use the blending method since the component (i) and the component (ii) can be synthesized to have an optimum structure.

(1) A copolymer (I′-1) having a structure shown by [A-B] is synthesized by block polymerization, and aside from this, a copolymer (II′-1) having a structure shown by [A-B-A] is synthesized by block polymerization. The copolymer (I′-1) and the copolymer (II′-1) are blended in a given mass ratio, and then hydrogenated to obtain a copolymer composition in which conjugated diene compound-derived double bonds included in the copolymer (I′-1) and the copolymer (II′-1) are hydrogenated. Then, other components are optionally mixed in the copolymer composition to obtain a pressure-sensitive adhesive composition.

(2) A copolymer (I′-1) having a structure shown by [A-B] is synthesized by block polymerization, and is hydrogenated to obtain a copolymer (I-1) in which conjugated diene compound-derived double bonds included in the copolymer (I′-1) are hydrogenated. Aside from this, A copolymer (II′-1) having a structure shown by [A-B-A] is synthesized by block polymerization, and is hydrogenated to obtain a copolymer (II-1) in which conjugated diene compound-derived double bonds included in the copolymer (II′-1) are hydrogenated. The copolymer (I-1) and the copolymer (II-1) are blended in a given mass ratio to obtain a copolymer composition that includes the component (i) and the component (ii). Then, other components are optionally mixed in the copolymer composition to obtain a pressure-sensitive adhesive composition.

As a hydrogenation catalyst, a compound containing a Ib, IVb, Vb, VIb, VIIb, or VIII group metal may be used. For example, a compound containing Ti, V, Co, Ni, Zr, Ru, Rh, Pd, Hf, Re, or Pt may be used as the hydrogenation catalyst. Examples of the hydrogenation catalyst include a metallocene compound containing Ti, Zr, Hf, Co, Ni, Rh, or Ru, and more specifically a heterogeneous catalyst in which a metal such as Pd, Ni, Pt, Rh, or Ru is supported by a carrier such as carbon, silica, alumina, diatomite, or basic activated carbon.

Specific examples of the metallocene compound include a Kaminsky catalyst that contains cyclopentadienyl rings (Cp rings) or ligands obtained by replacing hydrogen on a Cp ring by an alkyl group, an ansa-metallocene catalyst, an uncrosslinked half-metallocene catalyst, a crosslinked half-metallocene catalyst, and the like.

Further examples of the hydrogenation catalyst include a homogeneous Ziegler catalyst that contains an organic salt or an acetylacetone salt of a metal element such as Ni or Co and a reducing agent such as an organoaluminum compound, and an organometallic compound containing Ru, Rh, or the like.

Among these, the metallocene compound containing Ti, Zr, Hf, Ni, Co, Ru, or Rh is preferable. It is more preferable to use the metallocene compound containing Ti, Zr, or Hf. In particular, a catalyst obtained by reacting a titanocene compound with an alkoxylithium is an inexpensive and industrially useful catalyst.

Specific examples include catalysts disclosed in JP-A-1-275605, JP-A-5-271326, JP-A-5-271325, JP-A-5-222115, JP-A-11-292924, JP-A-2000-37632, JP-A-59-133203, JP-A-63-5401, JP-A-62-218403, JP-A-7-90017, JP-B-43-19960, and JP-B-47-40473. These catalysts may be used either individually or in combination.

The pressure-sensitive adhesive composition according to the present invention is preferably produced by the following method (coupling method), for example. When using the coupling method, the component (i) and the component (ii) can be synthesized by a one-pot process simply at low cost. Moreover, the ratio of the component (i) and the component (ii) can be controlled by selecting the type and the amount of coupling agent, for example.

The coupling method includes a first step of synthesizing a copolymer (I′-1) having a structure shown by [A-B] by block polymerization, a second step of coupling part of the copolymer (I′-1) having a structure shown by [A-B] using a coupling agent Y-Zₓ (wherein “Y” represents a coupling agent residue, “Z” represents an elimination group, and “X” represents an integer equal to or larger than 2) to synthesize a copolymer (II′-1) having a structure shown by {[A-B]ₓ-Y}, and a third step of hydrogenating the copolymer (I′-1) having a structure shown by [A-B] and the copolymer (II′-1) having a structure shown by {[A-B]ₓ-Y} to obtain a copolymer composition in which 80% or more of conjugated diene compound-derived double bonds included in the copolymer (I′-1) and the copolymer (II′-1) are hydrogenated.

Examples of the coupling agent include halogen compounds such as methyldichlorosilane, dimethyldichlorosilane, methyltrichlorosilane, butyltrichlorosilane, tetrachlorosilane, dibromoethane, tetrachlorotin, butyltrichlorotin, tetrachlorogermanium, and bis(trichlorosilyl)ethane; epoxy compounds such as epoxidized soybean oil; carbonyl compounds such as diethyl adipate, dimethyl adipate, dimethyl terephthalate, and diethyl terephthalate; polyvinyl compounds such as divinylbenzene; polyisocyanates; and the like. It is preferable to use methyldichlorosilane, dimethyldichlorosilane, methyltrichlorosilane, or tetrachlorosilane from the viewpoint of industrial availability and high reactivity.

### [3] Pressure-Sensitive Adhesive Body

The pressure-sensitive adhesive body according to the present invention includes a substrate and a pressure-sensitive adhesive layer formed on the surface of the substrate, the pressure-sensitive adhesive layer including the pressure-sensitive adhesive composition according to the present invention.

Examples of the substrate include a substrate formed of an inorganic material such as a metal or glass; a substrate formed of a synthetic resin material such as a polyolefin resin or a polyester resin; a substrate formed of a cellulose material; and the like. These substrates may be used individually, or a laminate formed by stacking 2 or more substrates may be used. It is preferable to use a substrate formed of a polyolefin resin from the viewpoint of productivity, handling capability, and cost. The thickness of the substrate is not particularly limited. When deforming the pressure-sensitive adhesive layer and the substrate in the shape of a roll or the like, the thickness of the substrate is preferably 1.0 mm or less, more preferably 300 μm or less, and particularly preferably 100 μm or less, but not limited specifically. The lower limit is believed to be about 20 μm.

The pressure-sensitive adhesive body may be produced using an arbitrary method. For example, the pressure-sensitive adhesive body may be produced by laminating a pressure-sensitive adhesive on the surface of a substrate formed of a synthetic resin, and integrally stacking the substrate and the pressure-sensitive adhesive layer, or integrally stacking a substrate and a pressure-sensitive adhesive layer by coextruding a pressure-sensitive adhesive composition for the pressure-sensitive adhesive layer and a resin composition for the substrate formed of a synthetic resin.

The pressure-sensitive adhesive may be laminated on the substrate formed of a synthetic resin using a solution coating method that applies a pressure-sensitive adhesive solution to the substrate, a dry lamination method, an extrusion coating method using a T-die, or the like. In this case, it is preferable to subject the substrate formed of a synthetic resin to a surface treatment such as primer application in advance in order to increase the bonding strength between the substrate layer and the pressure-sensitive adhesive layer. The substrate formed of a synthetic resin and the pressure-sensitive adhesive may be integrally stacked by coextrusion using an inflation method, a T-die method, or the like. It is particularly preferable to use the T-die coextrusion method among the above-mentioned methods since a high-quality pressure-sensitive adhesive body can be produced economically.

The thickness of the pressure-sensitive adhesive layer is preferably 3 to 50 μm, but not limited specifically. If the thickness of the pressure-sensitive adhesive layer is less than 3 μm, the pressure-sensitive adhesive layer may exhibit insufficient adhesion. If the thickness of the pressure-sensitive adhesive layer is more than 50 μm, the production cost may increase.

### EXAMPLES

The pressure-sensitive adhesive composition and the pressure-sensitive adhesive body according to the present invention are described below in more detail by way of examples. Note that the following examples merely illustrate some embodiments of the present invention. Therefore, the present invention is not limited to the following examples. In the examples and comparative examples, “part(s)” refers to “part(s) by mass”, and “%” refers to “mass %” unless otherwise indicated.

### (1) Synthesis of Component (i) and Component (ii) and Evaluation of Copolymer Composition

The component (i) and the component (ii) used as the raw materials for the pressure-sensitive adhesive body according to the present invention were synthesized. The synthesis method is described below. The property values of the component (i), the component (ii), or the copolymer composition were measured and evaluated by the following methods.

(1) Molecular Weight and Mass Ratio ((i)/(ii)) of Component (i) and Component (ii)

When producing the component (i) and the component (ii) by a one-pot process using the coupling method to obtain a copolymer composition, the polystyrene-reduced molecular weight of each component was determined by gel permeation chromatography (GPC, “HLC-8120GPC” manufactured by Tosoh Finechem Corporation). The mass ratio ((i)/(ii)) was calculated by separating the waveforms obtained by the measurement. When producing a mixture of the component (i) and the component (ii) using the blending method, the mass ratio ((i)/(ii)) was calculated from the blending ratio.

### (2) Mass Ratio (A/B) of Polymer Block A and Polymer Block B

The mass ratio of the polymer block A and the polymer block B was calculated from the amount of each raw material used when producing the copolymers of the component (i) and the component (ii).

### (3) Content (Vinyl Content) of 1,2-Vinyl Bonds and 3,4-Vinyl Bonds

The content of 1,2-vinyl bonds and 3,4-vinyl bonds was calculated by a Morello method utilizing infrared absorption spectrometry.

### (4) Hydrogenation Rate of Conjugated Diene Compound Unit (Hydrogenation Rate)

The hydrogenation rate of the conjugated diene compound unit was calculated from a 270 MHz, ¹H-NMR spectrum using carbon tetrachloride as a solvent.

### (5) MFR₂₃₀° _{C., 21.2 N} (Melt Flow Rate)

The MFR₂₃₀° _{C., 21.2 N} was measured in accordance with JIS K7210 at a temperature of 230° C. and a load of 21.2 N.

### (6) tan δ (80° C.), tan δ (20° C.), and G′ (20° C.)

The loss tangent tan δ (80° C.), the loss tangent tan δ (20° C.), and the storage modulus G (20° C.) were measured in a temperature variance range of −60 to 100° C. at a temperature increase rate of 5° C./min, a strain of 0.14%, and a frequency of 10 Hz using an ARES measuring instrument (manufactured by TA Instruments Japan).

### Example 1

A reaction vessel of which the atmosphere was replaced by nitrogen was charged with 500 parts by mass of deaerated and dehydrated cyclohexane, 10 parts by mass of styrene, and 5 parts by mass of tetrahydrofuran. 0.13 parts by mass of n-butyllithium was added to the mixture at 40° C. of polymerization start temperature to polymerize the monomers while increasing the temperature. After the polymerization conversion rate reached about 100%, the reaction solution was cooled to 15° C. After the addition of 90 parts by mass of 1,3-butadiene, the monomers were further polymerized while increasing the temperature.

After the polymerization conversion rate reached about 100%, 0.07 parts by mass of methyldichlorosilane was added as a coupling agent, and the mixture was allowed to undergo a coupling reaction. After completion of the coupling reaction, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 170,000.

After the addition of 0.03 parts by mass of diethylaluminum chloride and 0.06 parts by mass of bis(cyclopentadienyl)titanium furfuryloxychloride to the reaction vessel, the mixture was stirred. The mixture was allowed to undergo a hydrogenation reaction at a hydrogen gas supply pressure of 0.7 MPa-Gauge and a reaction temperature of 80° C. When absorption of hydrogen was completed, the reaction solution was allowed to reach ambient temperature and normal pressure, and was discharged from the reaction vessel to obtain a copolymer composition containing the component (i) and the component (ii). The property evaluation results for the copolymer composition are shown in Table 1.

TABLE 1

| | Example | | | | | Comparative Example | | | | |
|---|---|---|---|---|---|---|---|---|---|---|
| | 1 | 2 | | 3 | 4 | 1 | 2 | 3 | 4 | 5 |
| Copolymer (I′) | A-B | A-B | — | A-B | A-B | — | — | — | A-B | A-B |
| Copolymer (II′) | (A-B)₂-Y | — | A-B-A | (A-B)₂-Y | (A-B)₂-Y | A-B-A | A-B-A | A-B-A | — | (A-B)₂-Y |
| Production method | Coupling | Blending | | Coupling | Coupling | — | — | — | — | Coupling |
| Vinyl bond content of | 65 | 54 | 65 | 65 | 68 | 64 | 40 | 40 | 54 | 41 |
| block B (%) | | | | | | | | | | |
| Mass ratio (i)/(ii) | 40/60 | 40/60 | | 20/80 | 35/65 | 0/100 | 0/100 | 0/100 | 100/0 | 40/60 |
| Mass ratio A/B | 10/90 | 15/85 | 15/85 | 10/90 | 20/80 | 15/85 | 20/80 | 10/90 | 10/90 | 12/88 |
| Hydrogenation rate (%) | 98 | 98 | 97 | 98 | 98 | 98 | 99 | 99 | 98 | 98 |
| MFR₂₃₀° _{C., 21.2N} | 7 | 10 | 5 | 5 | 4.1 | 5 | 15 | 12 | 10 | 10 |
| (g/10 min) | | | | | | | | | | |

| | | | | | | | | | |
|---|---|---|---|---|---|---|---|---|---|
| tanδ (20° C.) | 0.07 | 0.08 | 0.07 | 0.12 | 0.08 | 0.07 | 0.08 | 0.15 | 0.09 |
| tanδ (80° C.) | 0.13 | 0.14 | 0.14 | 0.15 | 0.10 | 0.16 | 0.15 | 0.27 | 0.12 |
| G′ (20° C.): (Pa) | 1.1 × 10⁶ | 1.3 × 10⁶ | 1.2 × 10⁶ | 1.7 × 10⁶ | 1.3 × 10⁶ | 2.0 × 10⁶ | 1.9 × 10⁶ | 0.3 × 10⁵ | 1.8 × 10⁶ |

* Copolymer I′ is a copolymer of the component (i) before hydrogenation, and copolymer II′ is a copolymer of the component (ii) before hydrogenation.

### Example 2

A reaction vessel of which the atmosphere was replaced by nitrogen was charged with 500 parts by mass of deaerated and dehydrated cyclohexane, 15 parts by mass of styrene, and 5 parts by mass of tetrahydrofuran. 0.10 parts by mass of n-butyllithium was added to the mixture at 40° C. of polymerization start temperature to polymerize the monomers while increasing the temperature. After the polymerization conversion rate reached about 100%, the reaction solution was cooled to 25° C. After the addition of 85 parts by mass of 1,3-butadiene, the monomers were further polymerized while increasing the temperature.

After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 130,000. After the addition of 0.04 parts by mass of tetrachlorosilane to the reaction vessel, the mixture was stirred. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B] in which conjugated diene compound-derived double bonds were hydrogenated (component (i)). The property evaluation results for the copolymer are shown in Table 1.

Aside from the foregoing, a reaction vessel of which the atmosphere was replaced by nitrogen was charged with 500 parts by mass of deaerated and dehydrated cyclohexane, 7.5 parts by mass of styrene, and 5 parts by mass of tetrahydrofuran. 0.10 parts by mass of n-butyllithium was added to the mixture at 40° C. of polymerization start temperature to polymerize the monomers while increasing the temperature. After the polymerization conversion rate reached about 100%, the reaction solution was cooled to 15° C. After the addition of 85 parts by mass of 1,3-butadiene, the monomers were further polymerized while increasing the temperature.

After the polymerization conversion rate reached about 100%, 7.5 parts by mass of styrene was added to the mixture. The mixture was then polymerized. After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 130,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B-A] in which conjugated diene compound-derived double bonds were hydrogenated (component (ii)). The property evaluation results for the copolymer are shown in Table 1.

The polymers were blended so that the mass ratio was 40/60. The polymers were poured into water with stirring, and the solvent was removed by steam stripping and then drying to obtain a copolymer composition containing the component (i) and the component (ii). The property evaluation results for the copolymer composition are shown in Table 1.

### Example 3

A reaction vessel of which the atmosphere was replaced by nitrogen was charged with 500 parts by mass of deaerated and dehydrated cyclohexane, 10 parts by mass of styrene, and 5 parts by mass of tetrahydrofuran. 0.12 parts by mass of n-butyl lithium was added to the mixture at 40° C. of polymerization start temperature to polymerize the monomers while increasing the temperature. After the polymerization conversion rate reached about 100%, the reaction solution was cooled to 15° C. After the addition of 90 parts by mass of 1,3-butadiene, the monomers were further polymerized while increasing the temperature.

After the polymerization conversion rate reached about 100%, 0.10 parts by mass of methyldichlorosilane was added as a coupling agent, and the mixture was allowed to undergo a coupling reaction.

After completion of the coupling reaction, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 180,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer composition containing the component (i) and the component (ii). The property evaluation results for the copolymer composition are shown in Table 1.

### Example 4

A reaction vessel of which the atmosphere was replaced by nitrogen was charged with 500 parts by mass of deaerated and dehydrated cyclohexane, 20 parts by mass of styrene, and 5 parts by mass of tetrahydrofuran. 0.19 parts by mass of n-butyllithium was added to the mixture at 40° C. of polymerization start temperature to polymerize the monomers while increasing the temperature. After the polymerization conversion rate reached about 100%, the reaction solution was cooled to 15° C. After the addition of 80 parts by mass of 1,3-butadiene, the monomers were further polymerized while increasing the temperature.

After the polymerization conversion rate reached about 100%, 0.13 parts by mass of dimethyldichlorosilane was added as a coupling agent, and the mixture was allowed to undergo a coupling reaction.

After completion of the coupling reaction, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 100,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer composition containing the component (i) and the component (ii). The property evaluation results for the copolymer composition are shown in Table 1.

### Comparative Example 1

A reaction vessel of which the atmosphere was replaced by nitrogen was charged with 500 parts by mass of deaerated and dehydrated cyclohexane, 7.5 parts by mass of styrene, and 5 parts by mass of tetrahydrofuran. 0.10 parts by mass of n-butyllithium was added to the mixture at 40° C. of polymerization start temperature to polymerize the monomers while increasing the temperature. After the polymerization conversion rate reached about 100%, the reaction solution was cooled to 15° C. After the addition of 85 parts by mass of 1,3-butadiene, the monomers were further polymerized while increasing the temperature.

After the polymerization conversion rate reached about 100%, the reaction solution was heated to 80° C. After the addition of 7.5 parts by mass of styrene, the monomers were further polymerized while increasing the temperature. After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 130,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B-A] in which conjugated diene compound-derived double bonds were hydrogenated (component (ii)). The property evaluation results for the copolymer are shown in Table 1.

### Comparative Example 2

A reaction vessel of which the atmosphere was replaced by nitrogen was charged with 500 parts by mass of deaerated and dehydrated cyclohexane, 10 parts by mass of styrene, and 2 parts by mass of tetrahydrofuran. 0.13 parts by mass of n-butyllithium was added to the mixture at 40° C. of polymerization start temperature to polymerize the monomers without changing the temperature. After the polymerization conversion rate reached about 100%, the reaction solution was cooled to 25° C. After the addition of 80 parts by mass of 1,3-butadiene, the monomers were further polymerized while increasing the temperature.

After the polymerization conversion rate reached about 100%, the reaction solution was heated to 80° C. After the addition of 10 parts by mass of styrene, the monomers were further polymerized while increasing the temperature. After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 90,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B-A] in which conjugated diene compound-derived double bonds were hydrogenated (component (ii)). The property evaluation results for the copolymer are shown in Table 1.

### Comparative Example 3

A reaction vessel of which the atmosphere was replaced by nitrogen was charged with 500 parts by mass of deaerated and dehydrated cyclohexane, 5 parts by mass of styrene, and 2 parts by mass of tetrahydrofuran. 0.13 parts by mass of n-butyllithium was added to the mixture at 40° C. of polymerization start temperature to polymerize the monomers without changing the temperature. After the polymerization conversion rate reached about 100%, the reaction solution was cooled to 25° C. After the addition of 90 parts by mass of 1,3-butadiene, the monomers were further polymerized while increasing the temperature.

After the polymerization conversion rate reached about 100%, the reaction solution was heated to 80° C. After the addition of 5 parts by mass of styrene, the monomers were further polymerized while increasing the temperature. After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 100,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B-A] in which conjugated diene compound-derived double bonds were hydrogenated (component (ii)). The property evaluation results for the copolymer are shown in Table 1.

### Comparative Example 4

A reaction vessel of which the atmosphere was replaced by nitrogen was charged with 500 parts by mass of deaerated and dehydrated cyclohexane, 10 parts by mass of styrene, and 5 parts by mass of tetrahydrofuran. 0.10 parts by mass of n-butyllithium was added to the mixture at 40° C. of polymerization start temperature to polymerize the monomers while increasing the temperature. After the polymerization conversion rate reached about 100%, the reaction solution was cooled to 25° C. After the addition of 90 parts by mass of 1,3-butadiene, the monomers were further polymerized while increasing the temperature.

After the polymerization conversion rate reached about 100%, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 130,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer having a structure shown by [A-B] in which conjugated diene compound-derived double bonds were hydrogenated (component (i)). The property evaluation results for the copolymer are shown in Table 1.

### Comparative Example 5

A reaction vessel of which the atmosphere was replaced by nitrogen was charged with 500 parts by mass of deaerated and dehydrated cyclohexane, 12 parts by mass of styrene, and 2 parts by mass of tetrahydrofuran. 0.18 parts by mass of n-butyllithium was added to the mixture at 40° C. of polymerization start temperature to polymerize the monomers without changing the temperature. After the polymerization conversion rate reached about 100%, the reaction solution was cooled to 25° C. After the addition of 88 parts by mass of 1,3-butadiene, the monomers were further polymerized while increasing the temperature.

After the polymerization conversion rate reached about 100%, 0.11 parts by mass of dimethyldichlorosilane was added as a coupling agent, and the mixture was allowed to undergo a coupling reaction.

After completion of the coupling reaction, the resulting product was allowed to stand for 10 minutes while supplying hydrogen gas at a pressure of 0.4 MPa-Gauge. The resulting polymer was partially removed and analyzed by GPC. The weight average molecular weight of the polymer was about 110,000. The mixture was allowed to undergo a hydrogenation reaction under the same conditions as in Example 1. When absorption of hydrogen was completed, the reaction solution was allowed to reach ambient temperature and normal pressure, and was discharged from the reaction vessel to obtain a copolymer composition containing the component (i) and the component (ii). The property evaluation results for the copolymer composition are shown in Table 1.

### (2) Evaluation of Properties of Pressure-Sensitive Adhesive Body

### Examples 5 to 8 and Comparative Examples 6 to 10

The copolymers or the copolymer compositions obtained in Examples 1 to 4 and Comparative Examples 1 to 5 were used. 5 parts by mass of a tackifier (alicyclic saturated hydrocarbon resin, “Arkon P125” manufactured by Arakawa Chemical Industries, Ltd.), 1 part by mass of an antioxidant (“Irganox 1010” manufactured by Ciba Specialty Chemicals), and 0.5 parts by mass of a UV absorber (“Tinuvin 326” manufactured by Ciba Specialty Chemicals) were added to 100 parts by mass of the copolymer composition. Toluene was added to the mixture to obtain a toluene solution. A substrate (PET film, thickness: 25 μm) of which the surface was subjected to a corona discharge treatment in advance was provided. The toluene solution was applied to the surface of the substrate subjected to the corona discharge treatment, and then dried to form a pressure-sensitive adhesive layer having a thickness of 10 μm. A pressure-sensitive adhesive body (surface protective film) in which the pressure-sensitive adhesive layer was formed on the surface of the substrate was thus obtained. The pressure-sensitive adhesive body was rolled, and the properties of the pressure-sensitive adhesive body were evaluated. The property values of the pressure-sensitive adhesive body were measured and evaluated by the following methods. The results are shown in Table 2.

TABLE 2

| | | Example | | | | Comparative Example | | | | |
|---|---|---|---|---|---|---|---|---|---|---|
| Pressure-sensitive adhesive composition | | 5 | 6 | 7 | 8 | 6 | 7 | 8 | 9 | 10 |
| Copolymer composition | | 1 | 2 | 3 | 4 | 1 | 2 | 3 | 4 | 5 |
| Adhesion | High-speed peelability | 5.0 | 4.7 | 3.0 | 4.5 | 4.1 | 4.2 | 4.0 | >20 | 3.0 |
| (N/25 mm) | | Good | Good | Good | Good | Good | Good | Good | Bad | Good |
| | Low-speed peelability | 5.2 | 3.1 | 2.6 | 2.6 | 3.3 | 3.8 | 5.0 | >20 | 2.8 |
| | | Good | Good | Good | Good | Good | Good | Good | Bad | Good |
| Holding power | Low-load holding power | 5 | 1 | 8 | 1 | 10 | 0 | 2 | 0 | 0 |
| (mm) | | Good | Good | Good | Good | Good | Good | Good | Good | Good |
| | High-load holding power | 10 | 5 | 15 | 3 | 70 | 0 | 5 | 0 | 1 |
| | | Good | Good | Good | Good | Bad | Good | Good | Good | Good |

| | | | | | | | | | |
|---|---|---|---|---|---|---|---|---|---|
| Lifting | Good | Good | Good | Good | Bad | Bad | Bad | Good | Bad |
| Adhesive residue | Good | Good | Good | Good | Good | Good | Good | Bad | Good |

### (1) Adhesion

The adhesion was measured in accordance with JIS Z0237. The adhesion when the tensile rate was set at 300 mm/min (low speed) (low-speed peelability) and the adhesion when the tensile rate was set at 30 m/min (high speed) (high-speed peelability) were measured. The low-speed peelability was evaluated as follows. Specifically, when the adhesion at a low tensile rate was 2 to 10 N/25 mm, the low-speed peelability was evaluated as “Good”. When the adhesion at a low tensile rate was less than 2 N/25 mm, the adhesion was insufficient and when the adhesion at a low tensile rate was more than 10 N/25 mm, the adhesion was too high. Therefore, both low-speed peelabilities were evaluated as “Bad”. The high-speed peelability was evaluated as follows. Specifically, when the adhesion at a high tensile rate was 2 to 10 N/25 mm, the high-speed peelability was evaluated as “Good”. When the adhesion at a high tensile rate was less than 2 N/25 mm or more than 10 N/25 mm, the high-speed peelability was evaluated as “Bad”.

### (2) Holding Power

A specimen cut into 25 mm width was press-bonded in one round trip to an SS304 steel sheet defined in JIS Z0237 at ambient temperature using a roller having the weight of 2 kg at a speed of 300 mm/min. The resulting product was allowed to stand at 23° C. for 30 minutes. A grip portion was formed by peeling one end of the specimen in the longitudinal direction. A bench mark was provided in the peeling boundary area. The specimen was allowed to stand at 40° C. for 30 minutes in a state in which the test sheet was held horizontally with the bonding side facing downward. A weight of 30 g was attached to the grip portion of the specimen, and was then suspended. The peeling length was measured after 30 minutes. The peeling length was taken as a holding power at a low load (low-load holding power). Likewise, a weight of 60 g was attached to the grip portion of the specimen, and was then suspended. The peeling length was measured after 30 minutes. The peeling length was taken as a holding power at a high load (high-load holding power).

The low-load holding power was evaluated as follows. Specifically, when the peeling length at a low load was 10 mm or less, the low-load holding power was evaluated as “Good”. When the peeling length at a low load was more than 10 mm, the low-load holding power was evaluated as “Bad”. The high-load holding power was evaluated as follows. Specifically, when the peeling length at a high load was 20 mm or less, the high-load holding power was evaluated as “Good”. When the peeling length at a high load was more than 20 mm, the high-load holding power was evaluated as “Bad”.

### (3) Lifting

The surface protective film was bonded to an adherend (acrylic sheet having a thickness of 2 mm, Paraglas cast sheet manufactured by Kuraray Co., Ltd.). The product was then allowed to stand at 40° C. for one week. A case where the pressure-sensitive adhesive layer was not peeled off from the adherend was evaluated as “Good”, and a case where even one portion of the pressure-sensitive adhesive layer was peeled off from the adherend was evaluated as “Bad”.

### (4) Adhesive Residue

The surface protective film was bonded to an adherend (the above-mentioned acrylic sheet). The product was then allowed to stand at 40° C. for one week, and the surface protective film was removed. A case where the pressure-sensitive adhesive layer did not remain on the surface of the adherend without being contaminated after peeling off the surface protective film from the adherend was evaluated as “Good”, and a case where the pressure-sensitive adhesive layer remained on the surface of the adherend with being contaminated after removing the surface protective film from the adherend was evaluated as “Bad”.

### Evaluation Results

The pressure-sensitive adhesive bodies (surface protective films) of Examples 5 to 8 exhibited excellent pressure-sensitive adhesive properties including adhesion and holding power and the like, and achieved good results for lifting and adhesive residue. On the other hand, when using the pressure-sensitive adhesive bodies (surface protective films) of Comparative Examples 5 to 7 and 9, the pressure-sensitive adhesive layer was lifted up from the surface of the adherend when one week has elapsed after bonding the film to the surface of the adherend so that the film was peeled off. When using the pressure-sensitive adhesive body (surface protective film) of Comparative Example 8, the pressure-sensitive adhesive remained on the surface of the adherend after removing the film from the surface of the adherend so that the surface of the adherend was contaminated. The pressure-sensitive adhesive body of Comparative Example 6 had a problem in that the high-load holding power was insufficient. The pressure-sensitive adhesive body of Comparative Example 9 had a problem in that the high-speed peelability and the low-speed peelability were insufficient and the adhesion was too high (i.e., hard to peel off).

### INDUSTRIAL APPLICABILITY

The pressure-sensitive adhesive composition and the pressure-sensitive adhesive body according to the present invention exhibit excellent pressure-sensitive adhesive properties including holding power and adhesion, and can effectively prevent problems such as lifting and an adhesive residue. Therefore, the pressure-sensitive adhesive composition according to the present invention can be suitably used as a pressure-sensitive adhesive composition for forming a pressure-sensitive adhesive layer of a surface protective film used for a specular finish member, an optically transparent member, or the like of which the surface must be protected.

1-9. (canceled)

10. A pressure-sensitive adhesive composition comprising a copolymer composition that includes a component (i) and a component (ii), the component (i) being a copolymer (I) obtained by hydrogenating a conjugated diene compound-derived double bond of a copolymer (I′) that includes a polymer block A and a polymer block B, the copolymer (I′) having a structure shown by [A-B]ₙ (wherein “A” represents the polymer block A, “B” represents the polymer block B, and “n” represents an integer from 1 to 3) and having an aromatic alkenyl compound unit content of 5 mass % or more and less than 30 mass %, the component (ii) being a copolymer (II) obtained by hydrogenating a conjugated diene compound-derived double bond of a copolymer (II′) that includes the polymer block A and the polymer block B, the copolymer (II′) including the polymer blocks A at two terminals and at least one polymer block B in the intermediate portion, and having an aromatic alkenyl compound unit content of 5 mass % or more and less than 30 mass %, the mass ratio of the component (i) and the component (ii) being 90:10 to 10:90, the mass ratio of the total amount of the polymer block A and the total amount of the polymer block B included in the copolymer (I′) and the copolymer (II′) being 5:95 to 29:71, 80% or more of conjugated diene compound-derived double bonds included in the copolymer (I′) and the copolymer (II′) being hydrogenated, the polymer block A being a polymer block having an aromatic alkenyl compound unit content of 80 mass % or more, and the polymer block B being a polymer block having a conjugated diene compound unit content of 50 mass % or more and a conjugated diene compound-derived vinyl bond content of 50% or more.

11. The pressure-sensitive adhesive composition according to claim 10, wherein the copolymer (I′) and the copolymer (II′) have an aromatic alkenyl compound unit content of 5 mass % or more and less than 25 mass %.

12. The pressure-sensitive adhesive composition according to claim 10, wherein the copolymer (I′) is a copolymer having a structure shown by [A-B], the copolymer (II′) is a copolymer having a structure shown by [A-B-A], and the mass ratio of the component (i) and the component (ii) is 80:20 to 20:80, provided that the polymer blocks A or the polymer blocks B may be the same or different polymer blocks.

13. The pressure-sensitive adhesive composition according to claim 10, wherein the copolymer (I′) is a copolymer having a structure shown by [A-B], the copolymer (II′) is a copolymer having a structure shown by {[A-B]ₓ-Y} (wherein “x” represents an integer equal to or larger than 2, and “Y” represents a coupling agent residue), and the mass ratio of the component (i) and the component (ii) is 50:50 to 20:80, provided that the polymer blocks “A” or the polymer blocks “B” may be the same or different polymer blocks.

14. The pressure-sensitive adhesive composition according to claim 10, wherein the polymer block A includes a styrene unit as the aromatic alkenyl compound unit, and the polymer block B includes at least one repeating unit selected from the group consisting of a 1,3-butadiene unit and an isoprene unit as the conjugated diene compound unit.

15. The pressure-sensitive adhesive composition according to claim 10, wherein the copolymer composition further includes a tackifier as a component (iii) in addition to the component (i) and the component (ii), the content of the component (iii) being 2 to 50 parts by mass with respect to the total amount of 100 parts by mass of the component (i) and the component (ii).

16. The pressure-sensitive adhesive composition according to claim 10, wherein the copolymer composition has an MFR measured at a temperature of 230° C. and a load of 21.2 N of 1 to 100 g/10 min, a loss tangent tan δ (20° C.) in a viscoelastic spectrum of 0.15 or less, a loss tangent tan δ (80° C.) of 0.10 or more, and a storage modulus G′ (20° C.) of 1.8×10⁶ Pa or less.

17. A method of producing the pressure-sensitive adhesive composition according to claim 10, the method comprising a first step of synthesizing a copolymer (I′-1) having a structure shown by [A-B] by block polymerization, a second step of coupling part of the copolymer (I′-1) having a structure shown by [A-B] using a coupling agent Y-Zₓ (wherein “Y” represents a coupling agent residue, “Z” represents an elimination group, and “X” represents an integer equal to or larger than 2) to synthesize a copolymer (II′-1) having a structure shown by {[A-B]ₓ-Y}, and a third step of hydrogenating the copolymer (I′-1) having a structure shown by [A-B] and the copolymer (II′-1) having a structure shown by {[A-B]ₓ-Y} to obtain a copolymer composition in which 80% or more of conjugated diene compound-derived double bonds included in the copolymer (I′-1) and the copolymer (II′-1) are hydrogenated, the polymer block A being a polymer block having an aromatic alkenyl compound unit content of 80 mass % or more, and the polymer block B being a polymer block having a conjugated diene compound unit content of 50 mass % or more and a conjugated diene compound-derived vinyl bond content of 50% or more.

18. A pressure-sensitive adhesive body comprising a substrate and a pressure-sensitive adhesive layer formed on the surface of the substrate, the pressure-sensitive adhesive layer including the pressure-sensitive adhesive composition according to claim 10.
